(19) United States
(12) Patent Application Publication
(10) Pub. No.: US 2002/0040329 A1
(43) Pub. Date: Apr. 4, 2002

(54) Data presentation for electronic purchasing system

(76) Inventors: Roy Cohen, Hod Hasharon (IL); Boaz Reuven, Hod Hasharon (IL)

Correspondence Address: MARTIN FLEIT, FLEIT KAIN GIBBONS GUTMAN & BONGINI, 520 BRICKELL KEY DRIVE #A201, MIAMI, FL, 33131, US

(21) Appl. No.: 09/770,110

(22) Filed: Jan. 24, 2001

(30) Foreign Application Priority Data
Oct. 2, 2000 (IL) 138819

(51) Int. Cl. G06F 17/60

(52) U.S. Cl. 705/27

(57) ABSTRACT

There is provided an electronic interactive purchasing on-line system more particularly an Internet-based system for allowing consumers to execute purchase transactions, wherein the display of goods on offer is in the form of a motion picture or any other similar program, presented on a CD with a compatible DVD unit. The system is primarily concerned with private consumer purchasing and not with commercial or business-to-business purchases.

The system comprises a computer system for presenting data and executing transactions by use of the internet, the computer system including at least one computer or an interactive TV set or a compatible DVD, a transaction management system, and at least one transactional database, being provided to the computer or interactive TV or a compatible DVD.

### FIELD OF THE INVENTION

The present invention relates to electronic interactive purchasing on-line system. More particularly, the invention provides an Internet-based system for allowing consumers to execute purchase transactions, wherein the display of goods on offer is in the form of a motion picture or any other similar program, presented on a CD with a compatible DVD unit. The invention is primarily concerned with private consumer purchasing and not with commercial or business-to-business purchases.

### BACKGROUND OF THE INVENTION

The purchase of goods through the internet is expanding, although not as rapidly as its proponents had expected. One reason is undoubtedly that the patience of the user is often stretched to the limit by the slow loading of graphic images before the desired item is located and its details are displayed on the screen. Presently the vast majority of surfers do not have fast access connections, and need to wait patiently while the pictorial content of each page is loaded. Prospective buyers of goods will typically visit several web sites for the purpose of comparing the offered goods and of course the price thereof. A typical search is rarely completed in less than 45 minutes.

In addition to prospective buyers searching for a predetermined article, the typical bricks-and-mortar sales outlet makes considerable effort to attract the impulse buyer, who buys an article not on his/her original shopping list. One technique is to display the type of goods bought by impulse buyers near the cashier, so that such goods catch the eye of persons waiting in line for check-out. Given the present methods by which data is presented to prospective customers on line, it is almost certain that impulse sales are far below what could be achieved.

Recent U.S. patents indicate the state of the art in the sale and display of goods through the Internet.

Klingman, U.S. Pat. No. 5,729,594 discloses an on-line secured financial transaction system though electronic media. Clearly this or a similar system is needed to provide confidence to potential buyers that the ordered goods will be sent and that user input data will not be misused.

Escallon, U.S. Pat. No. 5,799,157 describes a system and method for creating interactive electronic systems to present information and execute transactions. The central feature of the invention is the presentation of information in customized electronic books linked to databases as the information source.

Daly and Rate, U.S. Pat. No. 5,878,141 describes a computerized purchasing system and method for mediating transactions over an interactive network. The system is applicable when one of many vendors is to be selected and is concerned with handling different modes of payment and matching payment means offered by the buyer to payment means acceptable to a vendor.

Alloul et al., U.S. Pat. No. 6,032,130, propose a multimedia product catalog and electronic purchasing system, which is to combine large quantities of locally held product information with small volumes of remotely held data concerning price, availability and execution of a purchasing transaction.

Prior art methods of presenting product data to potential consumers are of the nature of “hard sell”—the products on offer are displayed electronically, but are in essence little different from the printed paper catalogues which are still in use, and there is little or no potential for impulse buying.

### OBJECTS OF THE INVENTION

It is therefore one of the objects of the present invention to obviate the disadvantages of prior art internet purchasing systems add to provide a less direct method of displaying goods for sale.

It is a further object of the present invention to encourage impulse buying on line.

It is a further aim of the present invention to encourage use of the buying system by indirectly presenting the goods on offer as part of an entertainment.

### SUMMARY OF THE INVENTION

The present invention achieves the above objects by providing a method executed in a computer system for presenting data and executing transactions by use of the internet, the computer system including at least one computer or an interactive TV set, or a compatible DVD, a transaction management system, and at least one transaction database, being provided to the said computer or interactive TV or a compatible DVD by any suitable means, and enabling a user to indicate interest in purchasing items displayed on a screen by electronically indicating said displayed item, whereupon the user is presented with an electronic form offering a choice of displaying further product details or of specifying details of the desired transaction.

In a preferred embodiment of the present invention the data provided comprises a motion picture film provided on a DVD CD or a directly broadcasted program.

In a most preferred embodiment of the present invention there is provided a system wherein the user's computer is an interactive television receiver connectable to the internet.

Yet further embodiments of the invention will be described hereinafter.

It will thus be realized that the novel goods display system of the present invention serves to psychologically distance the selection of goods for possible purchase from the field of commerce and to provide entertainment to viewers of the film. Viewers will be well informed that a mouse-click or pressure on a remote control button will enable the initiation of a purchasing procedure of the item indicated by the user, but such will not lessen enjoyment of the film being shown. As film images are fleeting by nature, some purchasing decisions will be the result of impulse buying—a marketing feature, which is least catered for by presently used electronic catalogues,

An important feature of the present invention is the choice offered to the user of immediate or delayed transaction execution. Where the film to be provided contains much entertainment value, viewers are likely to ask for delay in effecting a purchase transaction until the film has been seen in its entirety. The resulting satisfaction felt by the viewer will then increase the probability of him/her carrying out the purchase transaction. If the film being transmitted is oriented more to being recognizably commercial, at the expense of some of the entertainment content, viewers will be more inclined to execute a purchasing transaction immediately, although realizing that they might not then be able to view a later portion of the film being shown. The film will in all cases retain a measure of entertainment value. Those wishing merely to leaf through an electronic catalogue of goods for sale will make use of exist prior-art technologies.

It is well known that a DVD version of a given film is released some 3 to 4 months after its premiere. In order to bridge this gap a short version of the film which includes all item on sale will be made on a CD and given free at the cinema where the film is played. Such CD could be used with a home computer.

The invention will now be described further with reference to the accompanying drawings, which represent by example preferred embodiments of the invention. Structural details a shown only as far as necessary for a fundamental understanding thereof. The described examples, together with the drawings, will make apparent to those skilled in the art how further forms of the invention may be realized.

### SHORT DESCRIPTION OF THE DRAWINGS

In the drawings:

FIG. 1 is a block diagram representing a preferred embodiment of the system according to the invention;

FIG. 2 is a schematic view of a system for operating the method where the film is displayed on the screen of an interactive television receiver;

FIG. 3 is a schematic view of a system for operating the method where the film is displayed on the screen of a cellular telephone; and

FIG. 4 is a view of a remote controller suitable for use in combination with the embodiment referred to in FIG. 2.

### DETAILED DESCRIPTION OF THE INVENTION

The invention is a method executed in a computer system for presenting data in a new manner and executing transactions by use of the internet.

The computer system includes a plurality of client computers or interactive TV sets, only one of which is shown in the figure, a transaction management system having at least one transaction management server, and at least one transactional database. Systems of this type have been described in the prior art. Where no or very few changes are anticipated, the transaction management server may be replaced by a data storage medium, for example a DVD CD.

In the present invention the novelty is in provision of the data to a user's computer is in the form of a motion picture film or similar program providing entertainment value or other.

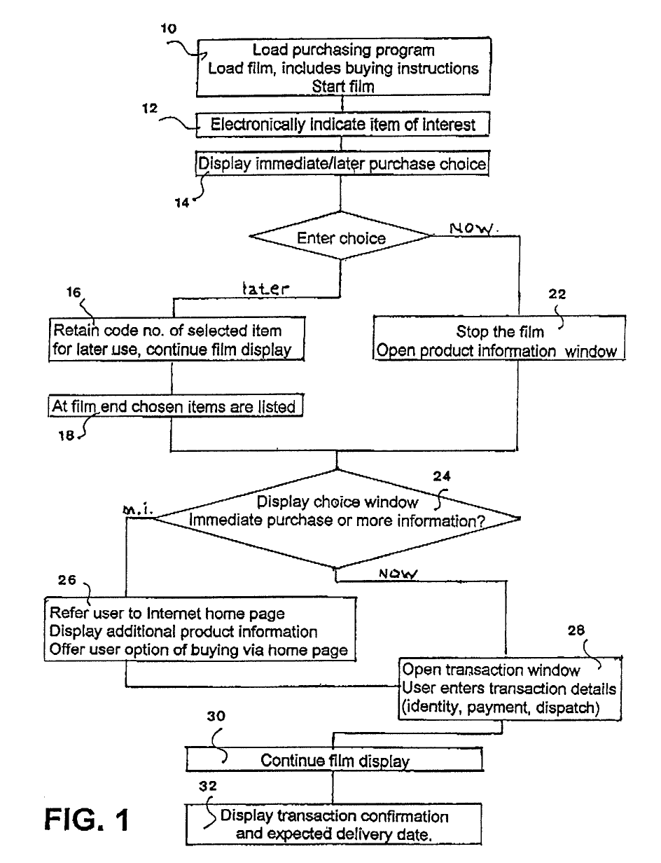

Referring now to FIG. 1, the block diagram illustrates the system. Users are informed that they may indicate interest in purchasing items displayed in the program by electronically indicating such item as displayed in the film 10, or program.

Upon indicating interest 12 in purchasing an electronically indicated item, the user is offered a choice of immediate purchase execution or of continuation of the program display 14. If program continuation is chosen, execution of the purchasing transaction is delayed until display of the program or film has been completed 18. However, the product code number(s) of the selected item(s) is retained in memory for later use 16.

When, according to user choice, an immediate purchasing decision 20 is made, the film is stopped and the screen displays product information 22. Such information will be provided so that in most cases this is sufficient for the user to make a buying decision. The user is then presented with an electronic choice form 24 offering a choice of first displaying further product details 26 or of immediately specifying details of the desired transaction 28. For example, a user wishing to buy an article of clothing will specify size and color in addition to the usually required information regarding payment and dispatch.

If the user requests mote details 26, he/she is automatically routed to the home page of the manufacturer of such product. The home site often enables the user to complete the intended purchase.

If the user chooses to return to the present program a transaction window opens 28 for the user to enter personal identification, the desired dispatch method and payment details in the displayed electronic form appearing on the screen. Optionally while film continues 30, the transaction is executed and supply confirmation 32 is displayed on the client computer screen thereafter.

With reference to the rest of the figures, similar reference numerals have been used to identify similar parts.

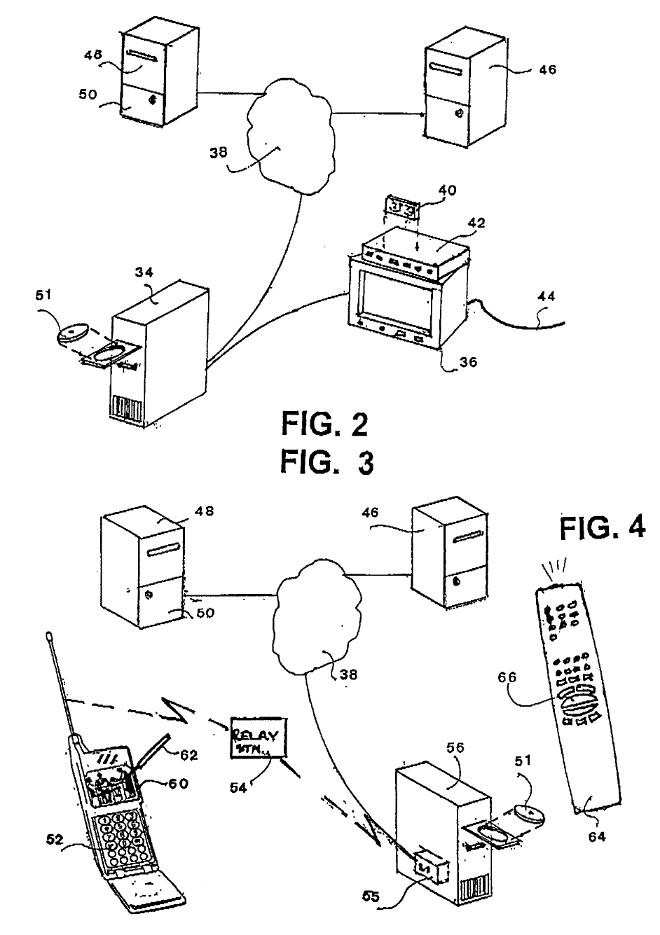

Referring now to FIG. 2, there is seen a representation of the system wherein the user's computer 34 is connected to an interactive television receiver 36; either machine is connected to the internet 38. The film to be displayed is either recorded on a CD 40 and displayed by means of a DVD 42, or sent directly to the TV receiver 36 by radio or cable 44. Product information is obtained through the internet 38 from server 46, and a transaction server 48 loaded with a transactional database 50 handles order receipt, payment method, credit, dispatch method and order transmission to the chosen supplier.

A special program 51 is provided on a CD to translate the user's electronic selection into a request for details of the displayed product.

FIG. 3 illustrates the method as described with regard to FIG. 2 wherein the film is displayed on a cellular telephone 52 connectable, through a relay station 54 to the internet 38. In the figure, the connection shown is indirect: the connection shown is through the modem 55 of uses home computer 56 which carries the program 51 needed to translate the user's electronic selection into a request for details of the displayed product. The telephone display screen 60 is somewhat larger than those in use today, and has a finer resolution. A pointer 62 is provided for purposes of product selection.

In an embodiment (not shown) where a cellular telephone is directly connected to the Internet (without the use of a home computer) the program 51 is loaded into the telephone by means of a card.

Seen in FIG. 4 is a remote control 64 which is most suitable for use in the method described with reference to FIG. 2. Users electronically indicate interest in purchasing a displayed item by positioning a cursor arrow on the item of interest and using a mouse-type clicker 66 on the remote control 64.

It is quite apparent that the system can not be utilized in cinemas. Accordingly a CD where all items on sale will be prepared. Such a CD will be free of charge given to visitors to a cinema to enable the viewer use the CD on a home computer. The CD could also have selected parts of the film or any other relevant data.

It is within the scope of the invention to use the system for similar and other purposes such as giving the user data on the participants of the film, providing statistics and the like.

The scope of the described invention is intended to include all embodiments coming within the meaning of the following claims. The foregoing examples illustrate useful forms of the invention but are not to be considered as limiting its scope, as those skilled in the art will readily be aware that additional variants and modifications of the invention can be formulated without departing from the meaning of the following claims.

We claim:

1. In a system executed in a computer system for presenting data and executing transactions by use of the internet, the computer system including at least one computer or TV set, a transaction management system having at least one transaction management server, and at least one transactional database, said data being provided to said computer or interactive TV set or compatible DVD, in the form of suitable means, and enabling a user to indicate interest in purchasing items displayed by electronically indicating said item, whereupon the user is presented with an electronic form offering a choice of displaying further product details or of specifying details of the desired transaction.

2. The system as claimed in claim 1, wherein said program comprises a motion picture film, provided on a DVD CD or directly transmitted.

3. The system as claimed in claim 1, wherein said transaction management system is stored on an external transaction management server.

4. The system as claimed in claim 1, wherein said transaction management system is stored on a DVD connected to said user's client computer.

5. The system as claimed in claim 1, wherein sad client computer is a cellular telephone connectable to the internet.

6. The system as claimed in claim 1, wherein users electronically indicate interest in purchasing said displayed item by use of a mouse-type clicker on a remote control.

7. A system as claimed in claim 1, wherein an interactive DVD is connected to the internet and which include hardware and software built-in.

8. A system as claimed in claim 1 wherein the system is used to provide the user with additional data on whatever is screened, on participants statistics and the like.
